(19) United States
(12) Patent Application Publication
(10) Pub. No.: US 2026/0269657 A1
(43) Pub. Date: Sep. 10, 2026

(54) DETERMINATION OF PREFERRED WIRELESS LASER POWER TRANSMISSION MODE

(71) Applicant: SPACE POWER LTD, Stanmore, Middlesex (GB)

(72) Inventors: Keval DATTANI, Stanmore (GB); Stephen SWEENEY, Stanmore (GB)

(73) Assignee: SPACE POWER LTD, Stanmore, Middlesex (GB)

(21) Appl. No.: 19/164,966

(22) PCT Filed: Mar. 11, 2024
(86) PCT No.: PCT/GB2024/050650

§ 371 Date: Sep. 12, 2025

(30) Foreign Application Priority Data
Mar. 13, 2023 (GB) 2303649.4

(51) Int. Cl. H02J 50/80; H02J 50/30

(52) U.S. Cl. CPC H02J 50/80; H02J 50/30

(57) ABSTRACT

A method of determining a preferred wireless power transmission mode is disclosed. Each wireless laser power transmission mode defines a combination of at least two laser pulses, each of the at least two laser pulses having a different wavelength. The method comprises receiving an indication of a power received at a wireless power receiver for each of a plurality of test wireless power transmissions received at the wireless power receiver, each of the wireless power transmissions corresponding to a different wireless power transmission mode; and determining a preferred wireless power transmission mode based on the indications of power received by the wireless power receiver for at least one of the test wireless power transmissions. A corresponding computer program, non-transitory memory and satellite are also provided.

### TECHNICAL FIELD

The present invention relates to a method of determining a preferred wireless power transmission mode. In particular, the method enables a preferred wireless power transmission mode to be determined based on a current state of the wireless power receiver. Other aspects of the invention relate to a corresponding computer program, non-transitory memory and satellite.

### BACKGROUND

While many devices powered by electricity that are not directly connected to a power source, such as satellites, have their own, on board source of power, such as a battery or photovoltaic cells, this source of power may be inadequate in certain situations. In some cases, the on board source of power may not provide enough power, or may no longer be able to provide power, to the device. For example, a battery may run flat or photovoltaic cells may no longer be in sunlight or the intensity of the sunlight may limit the power output.

In such situations, it is desirable to be able to be able to provide an external, wireless source of power. This may be done using a form of wireless power transmission.

Such forms of wireless power transmission comprise near-field techniques like inductive and capacitive coupling, and far-field techniques, using microwaves or lasers.

The efficiency of the transfer of power wirelessly will, in part, depend upon the device receiving the wireless power transmission—the wireless power receiver.

Depending upon a current state of the wireless power receiver, the optimal mode of wireless power transmission may vary. Little information may be known about the wireless power receiver and it may not be possible or practical to physically inspect the wireless power receiver to determine the current state of the wireless power receiver. This is particularly so for satellites in orbit or other space objects, such as extra-terrestrial rovers.

In order to enable efficient wireless power transmission, it would be preferable for there to be a method by which the preferred wireless power transmission mode can be determined, based on a current state of the wireless power receiver.

### SUMMARY OF INVENTION

The invention is defined in the independent claims. Embodiments of the invention are set out in the dependent claims.

According to a first aspect of the present disclosure, a method of determining a preferred wireless power transmission mode is provided. The method comprises receiving an indication of a power received at a wireless power receiver for each of a plurality of test wireless power transmissions received at the wireless power receiver, where at least two of the wireless power transmissions correspond to a different wireless power transmission mode. The method further comprises determining a preferred wireless power transmission mode based on the indications of power received by the wireless power receiver for at least one of the test wireless power transmissions.

According to this aspect of the disclosure, a plurality of test wireless power transmissions are made according to different wireless power transmission modes. This allows a preferred mode to be selected, without knowing beforehand any many specific details about the wireless power receiver, in order to optimise a desired characteristic of a future wireless power transmission.

Optionally, each wireless power transmission mode defines a combination of at least two laser pulses. In this case, each of the at least two laser pulses vary in one or more characteristics. For example, each of the at least two laser pulses may have at least a different wavelength, a different instantaneous or average power, or a different pulse mode (i.e., continuous, varying power, etc.) from each of the other at least two laser pulses.

Testing laser pulses having differing characteristics in this manner means that a preferred mode can be determined by comparing the power received at the wireless power received for each wireless power transmission mode. For example, using laser pulses at two power levels or wavelengths can give a first approximation of an EQE curve or an indication of how the wireless power transmission mode can be modified to improve the wireless power transmission. Laser pulses with different pulse modes may indicate a preferred pulse mode for reducing heating at the power receiver, for example.

Optionally, each of the plurality of test wireless power transmissions are received by the wireless power receiver sequentially. Preferably, between each test wireless power transmission the method further comprises determining the wireless power transmission mode to be used for the next test wireless power transmission.

In this manner, between each test wireless power transmission, the wireless power transmission mode to be used in the next test wireless power transmission is determined. Preferably, the determination of the wireless power transmission mode to be used for the next test wireless power transmission is based on at least one of the previously received indications of a power received at the wireless power receiver and the wireless power transmission mode used in a previous test wireless power transmission.

Using at least one previously used wireless power transmission mode to inform the next wireless power transmission mode to be tried allows an iterative process to optimise (or sufficiently improve) the wireless power transmission mode for a particular wireless power receiver. This means that the preferred wireless power transmission mode can be obtained more efficiently than if random wireless power transmission modes were tried, using fewer test transmissions and accordingly less power to determine the preferred wireless power transmission mode.

To determine the wireless power transmission mode to be used for the next test wireless power transmission, a genetic algorithm and/or machine learning may be used. A genetic algorithm allows for an efficient evolution of wireless power transmission modes to find an optimal (or sufficient according to operational parameters) wireless power transmission mode. Machine learning techniques can allow the algorithm to improve over time, especially if it learns based on the result of each application of the method (whether between the same wireless power transmitter and wireless power receiver, or between different wireless power transmitters and receivers).

In some implementations, no further wireless power transmission modes are determined if the power received from the most recent test wireless power transmission is either less than or within a certain threshold of the power received from the test wireless power transmission preceding the most recent test wireless power transmission.

That is, the method can end when the power received by the wireless power receiver from a test wireless power transmissions is less than the power received from the previous test wireless power transmission, or when the difference between the power received by the wireless power receiver from two consecutive test wireless power transmissions is within a certain threshold. This provides a means for determining when to stop the testing to find a preferable wireless power transmission mode-when improvements, or great enough improvements, are no longer being seen.

Alternatively, or in addition, the number of test wireless power transmissions in the plurality of test wireless power transmissions may not exceed a predetermined number. This provides an alternative or additional means for determining when to stop the method. This may be preferable when some information about the wireless power receiver is known (e.g., so a reasonably good wireless power transmission mode can be determined as a starting point). The number of test wireless power transmissions may also be based upon the power available for testing, and the average power used for each test (i.e., number of tests =total available test power * average power per test). This can prevent too much power being used in the process of determining the optimal wireless transmission mode.

Optionally, the plurality of test wireless power transmissions comprises an initial one or more test wireless power transmission, and wherein the each of the initial one or more test wireless power transmission corresponds to a predetermined wireless power transmission mode. In this manner, the method can begin with an initial predetermined pattern of test wireless power transmissions. For example, the parameters of the wireless power transmission modes tested can be varied in a predetermined manner in the initial one or more test wireless power transmissions. This can give the benefit of enabling the identification of a good starting point for a subsequent, iterative phase of the method. In some cases, the initial predetermined pattern of test wireless power transmissions may be based at least in part upon information regarding the wireless power receiver (e.g., different types of photovoltaic receivers may have different initial predetermined patterns of test wireless power transmissions).

Optionally, the method is configured to be used with a wireless power receiver comprising a photovoltaic cell. In this case, each wireless power transmission mode may comprise at least a number of different wavelengths equal to the number of junctions of the photovoltaic cell. That is, for a two-junction photovoltaic cell, each wireless power transmission mode may define a laser pulse comprising two lasers, each at a different wavelength. In this manner, the wireless power transmission modes will be more likely to achieve greater wireless power transmission efficiencies.

Preferably, each wireless power transmission mode may comprise more than one different wavelengths per junction. This gives a better chance of finding the best wavelength for a given junction and so increase the speed of the method. Furthermore, it can enable an approximation of the EQE curve for that junction and so enable better determinations of future wireless power transmission modes to be tested or even of the preferred wireless power transmission mode.

In either case, it is preferable that the wavelengths are reltated to the band gaps of the junctions of the photovoltaic cell. In this way, when the structure of a photovoltaic cell is known, an informed selection of wavelengths can be tested to find the best wavelength for this particular photovoltaic cell. For example, a wavelength slightly above and a wavelength slightly below the theoretical best wavelength for the junction of the photovoltaic cell could be used, to determine if in this case the best practical wavelength is longer or shorter than the theoretical one. This can increase the speed and efficiency of the method.

Optionally, determining a preferred wireless power transmission mode based on the indications of power received by the wireless power receiver for each of the test wireless power transmissions comprises selecting a wireless power transmission mode corresponding to one of the test wireless power transmissions as the preferred wireless power transmission mode.

In this implementation, one of the wireless power transmission modes that was tested is selected as the preferred wireless power transmission mode. This is a relatively computationally simple way of selecting a preferred wireless power transmission mode and the performance of the wireless power transmission mode will be known in advance, based on the testing.

Alternatively, determining a preferred wireless power transmission mode based on the indications of power received by the wireless power receiver for each of the test wireless power transmissions comprises: estimate an external quantum efficiency spectral response curve based on the indications of power received by the wireless power receiver for each of the test wireless power transmissions; and determining the preferred wireless power transmission mode based on the external quantum efficiency spectral response curve.

In this implementation, the results of the test wireless power transmissions are used to estimate the external quantum efficiency spectral response curve, and the preferred wireless power transmission mode can be determined based on the modelled external quantum efficiency spectral response curve. Whilst this is more computationally intensive, it can enable a better wireless power transmission mode to be determined with fewer tests, saving power and increasing the efficiency of the method. In this case, the preferred wireless power transmission mode may further be determined based on the lasers available to a wireless power transmitter.

Optionally, the preferred wireless power transmission mode is determined using artificial intelligence, such as a neural network. Using artificial intelligence, such as a neural network, can increase the speed and efficiency with which a preferred wireless power transmission mode can be determined, as well as increasing how optimal the preferred wireless power transmission mode may be.

In this case, the artificial intelligence is preferably trained on training data derived from previous implementations of the method. The use of training data derived from previous implementations of the method can lead to a more efficient method over time. For example, a neural network can look at the iterations of the wireless power transmission modes tested and the finally selected preferred wireless power transmission mode to better optimise the iterations tried in future implementations of the method. This may lead to a reduction in the number of wireless power transmission modes tested, reducing the power used in the method and increasing its speed.

Optionally, the preferred wireless power transmission mode is a wireless power transmission mode that enables the wireless power receiver to receive a maximum power or a specified amount of power. In this case, the method is configured to determine the wireless power transmission mode that will deliver the most power, meaning that the most energy can be transferred over the shortest amount of time, or a specified amount of power. Delivering the maximum amount of power can be beneficial, in the context of a satellite implementation, if satellites are only briefly passing, for example, whereas receiving a specified amount of power can be beneficial as it may enable the wireless power receiver to operate under preferred conditions (e.g., with a preferred received power).

Alternatively, the preferred wireless power transmission mode is a wireless power transmission mode that enables the most efficient wireless transfer of power from a wireless power transmitter to the wireless power receiver. In this case, the method is configured to determine the wireless power transmission mode that will deliver power most efficiently, meaning that more power can be transferred in total (as less will be lost due to inefficiencies), even if over a greater time. Again in the context of a satellite implementation, this can allow a satellite to provide power to more other satellites for a given amount of power stored, generated, or received at the satellite transmitting the power.

Alternatively, the preferred wireless power transmission mode is a wireless power transmission mode that enables the most efficient wireless transfer of power from a wireless power transmitter to the wireless power receiver whilst still providing a threshold amount of (e.g., instantaneous) power or energy. This can ensure that a wireless power receiver will receive at least the minimum amount of power required, in the most energy efficient manner.

Alternatively, the preferred wireless power transmission mode is a wireless power transmission mode that enables the most efficient wireless transmission of power from the wireless power receiver whilst still providing a threshold amount of (e.g., instantaneous) power or energy. This can ensure that a wireless power receiver will receive at least the minimum amount of power required, in the most energy efficient manner from the perspective of the wireless power transmitter. This may be beneficial if the wireless power transmitter only has a certain stored amount of energy, for example.

Alternatively or as an additional constraint, the preferred wireless power transmission mode is a wireless power transmission mode that enables wireless power transfer to the wireless power receiver without causing the temperature of the wireless power receiver and/or the wireless power transmitter to increase more than a threshold amount. In particular, this may be done whilst still providing a threshold amount of (e.g., instantaneous) power or energy. In this case, the method is configured to determined the wireless power transmission mode that will heat up the wireless power receiver and/or the wireless power transmitter the least, and therefore reducing impact on other components or functions of the wireless power receiver.

Alternatively or as an additional constraint, the preferred wireless power transmission mode is a wireless power transmission mode that causes least degradation of the wireless power receiver and/or the wireless power transmitter. In particular, this may be done whilst still providing a threshold amount of (e.g., instantaneous) power or energy. In this case, the method is configured to determined the wireless power transmission mode that will cause the least degradation of the wireless power receiver and/or the wireless power transmitter, prolonging its life.

Optionally, the method may further comprise, for each of the plurality of test wireless power transmissions, transmitting the test wireless power transmission to the wireless power receiver.

Optionally, the method may further comprise wirelessly transmitting power, from the wireless power transmitter to the wireless power receiver, according to the preferred wireless power transmission mode.

Optionally, one or both of the wireless power transmitter and the wireless power receiver are space objects. The method is particularly suited to having one or both of the wireless power transmitter and the wireless power receiver being satellites as it can enable a determination of a preferred wireless power transmission mode that takes into account the current state of the wireless power receiver which, for a satellite in orbit, cannot be directly inspected.

According to a second aspect of the present disclosure, a computer program is provided configured to cause a computing system to perform the method of the first aspect when executed.

According to a third aspect of the present disclosure, a non-transitory memory is provided having stored thereon the computer program of the second aspect.

According to a fourth aspect of the present disclosure, a satellite is provided that is configured to perform the method of the first aspect.

### BRIEF DESCRIPTION OF THE DRAWINGS

The disclosure will be further described, by way of example only, with reference to the accompanying drawings, in which:

FIG. 1 illustrates a method according to aspects of the invention;

FIG. 2 illustrates a system capable of implementing aspects of the invention;

FIG. 3 illustrates an external quantum efficiency (EQE) spectral response curve;

FIG. 4 illustrates a method according to aspects of the invention;

FIG. 5 illustrates an iterative process according to aspects of the invention;

FIG. 6 illustrates modelling an EQE spectral response curve;

FIG. 7 illustrates modelling another EQE spectral response curve; and

FIG. 8 illustrates a system according to aspects of the invention.

### DETAILED DESCRIPTION OF THE INVENTION

The present disclosure relates to a method of determining a preferred wireless power transmission mode for transmitting power wirelessly between a wireless power transmitter and a wireless power receiver.

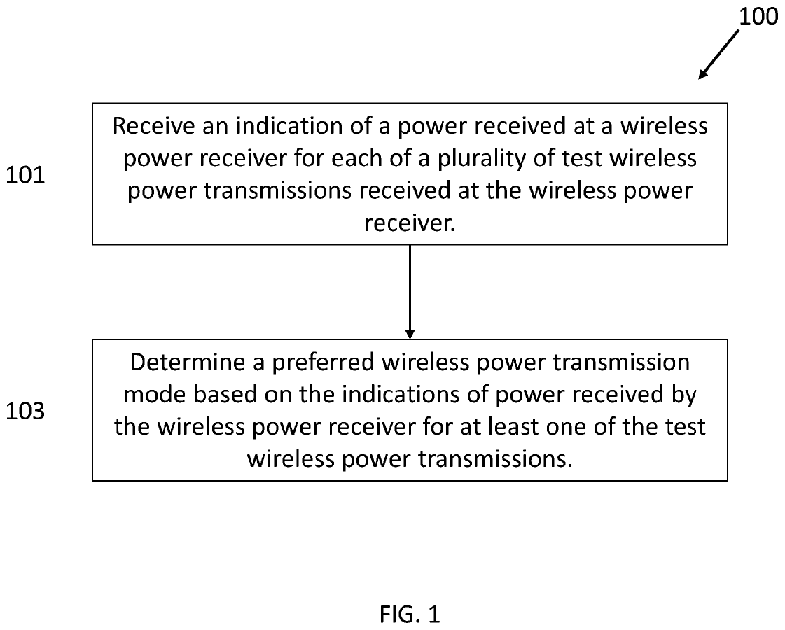

Method 100, illustrated in the flow chart of FIG. 1, provides a method for determining a preferred wireless power transmission mode. This method 100 enables a preferred wireless power transmission mode, such as a most efficient mode of wirelessly transmitting power, without requiring any knowledge of the wireless receiver (other than a type of wirelessly transmitted power that the wireless power receiver can receive).

The method 100 begins at step 101 by receiving an indication of a power received at a wireless power receiver for each of a plurality of test wireless power transmissions received at the wireless power receiver. At least two of the wireless power transmissions of the plurality of test wireless power transmissions correspond to a different wireless power transmission mode. However, some of the wireless power transmissions of the plurality of test wireless power transmissions may use a wireless power transmission mode previously tested, which can improve the certainty of the results obtained.

The wireless power transmission mode defines the characteristics of the wireless power transmission. The parameters that can be varied will depend upon the type of wireless power transmission being used.

Once the indication of the power received at the wireless power receiver for each of the plurality of test wireless power transmissions has been received at step 101, the method moves to step 103. At step 103, a determination is made of a preferred wireless power transmission mode based on the indications of power received by the wireless power receiver for each at least one of the test wireless power transmissions.

The preferred wireless power transmission may be determined based on different criteria in different operational scenarios. In some cases, a wireless power transmission mode that enables the wireless power receiver to receive a maximum power may be determined as the preferred wireless power transmission mode. This may be particularly useful when the transmission period for wirelessly transferring power is limited. This may be the case between satellites in orbit if the satellites are only within line of sight and power transmission range of each other for a relatively brief period of time.

In other cases, a wireless power transmission mode that enables the most efficient wireless transfer of power from a wireless power transmitter to the wireless power receiver may be determined as the preferred wireless power transmission mode. This will ensure that the least energy is wasted, and may be particularly beneficial if the wireless power transmitter only has a finite store of energy that can be transmitted, and/or when the available power transmission time is long.

In addition to these two examples, other factors that may be considered (in addition or instead of overall power transmission and power transmission efficiency) include how the wireless power transmission affects the wireless power receiver and/or the wireless power transmitter. For example, receiving wirelessly transmitted power will often cause the wireless power receiver to heat up. This may be undesirable, and so a wireless power transmission mode that will not cause the wireless power receiver to heat up more than a threshold amount may be determined as the wireless power transmission mode. This heating may cause degradation at the wireless power receiver, as may other factors depending upon the wireless power transmission technology used. For example, a laser intensity or pulse frequency may cause degradation of the wireless power receiver if lasers are used to transmit power wirelessly. A wireless power transmission mode that minimises or limits the degradation at the wireless power receiver may, therefore, be desired and so determined as the wireless power transmission mode.

The preferred wireless power transmission mode may be a power transmission mode determined by a number of these factors. For example, a power transmission mode that enables the wireless power receiver to receive a maximum amount of power without heating more than a threshold amount may be determined as the preferred wireless power transmission mode. Alternatively, the preferred wireless power transmission mode may be one that enables the most efficient wireless transfer of power from a wireless power transmitter to the wireless power receiver whilst still providing a threshold amount of (e.g., instantaneous) power or energy.

The preferred wireless power transmission mode may simply be selected from the wireless power transmission modes that were tested in the plurality of test wireless power transmissions in step 103. This has the advantage that the performance of this wireless power transmission mode is well known. On the other hand, the preferred wireless power transmission mode may be a wireless power transmission mode different from those tested in the plurality of test wireless power transmissions. In this case, the preferred wireless power transmission mode is a determined based on the results of the test wireless power transmissions (e.g., the power received at the wireless power receiver for each of the test wireless power transmissions). For example, a model of the wireless power receiver can be generated based on the plurality of test wireless power transmissions (e.g., an external quantum efficiency spectral response curve, as discussed below).

In some cases, artificial intelligence methods may be used to determine the preferred wireless power transmission mode. For example, a machine learning model, such as a neural network, may determine the preferred wireless power transmission mode based upon the wireless power modes tested by the plurality of test wireless power transmissions and the power received at the power receiver for each of these test transmissions. The machine learning model can be trained on data derived from previous implementations of the method (preferably with the same type of wireless power transmitter and receiver), and can be updated each time the method is applied based on the plurality of test wireless power transmissions.

In a preferred embodiment, lasers are used as the means for transmitting power wirelessly from the transmitter to the receiver. In this case, the parameters that may be defined in the wireless power transmission mode (and varied between test wireless power transmissions) include the number of lasers used, the wavelength or wavelengths of the laser or lasers used, the power of the laser or lasers used, and the pulse mode of the laser or lasers used.

The pulse mode defines whether the laser operates in a constant mode throughout the test transmission or whether the intensity or power of the laser varies throughout the test transmission (e.g., pulsed). For example, over a five second test transmission period, a laser may operate for three one second pulses, evenly distributed through the test transmission period with one second gaps between each pulse. It should also be noted that different lasers can operate in different pulse modes within a single test wireless power transmission. For example, a first laser having a first wavelength may operate at a continuous power for the duration of the test transmission period, whilst a second laser having a second wavelength may operate for three discreet pulses, distributed evenly across the test transmission period.

The power of a laser in this context may refer to both the instantaneous power at which the laser is operating at a given time or the average power over the test transmission period (i.e., the total energy transmitted by the laser during the test transmission period divided by the duration of the test transmission period). These may be related via the pulse mode of the laser. For example, the laser in the previous example operating for three one second pulses may operate at a constant instantaneous power whilst on of 50 W. The average power will then be equal to (3×50)/5=30 W, because over the five second transmission period the laser operates at a power of 50W for a total of three seconds. This would be the same average power as a 30 W laser operating continuously over the whole duration of the test transmission period. Both of these measures of power may be varied between different power transmission modes.

When determining the preferred mode for wireless power transmission via laser beam, each wireless power transmission mode should preferably define a combination of at least two laser pulses. Each of the two laser pulses of a wireless power transmission mode should vary in one or more parameters or characteristics of the wireless power transmission mode, such as those discussed above. For example, the laser pulses can vary in their wavelength, instantaneous or average power, and/or pulse mode.

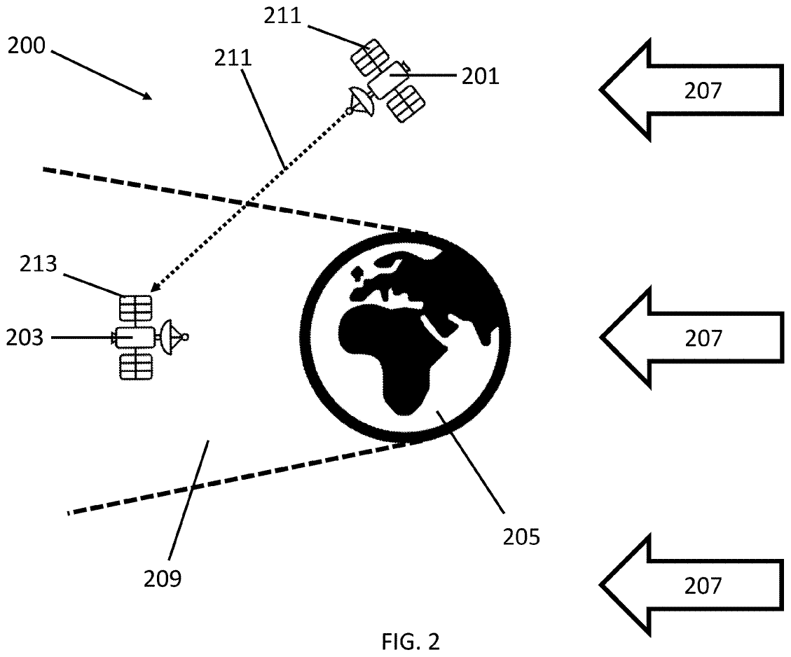

FIG. 2 illustrates an exemplary system 200 for using lasers to transmit power wirelessly. System 200 comprises a pair of satellites 201, 203. These satellites 201, 203 are both in orbit around the Earth 205. Light from the sun is represented by arrows 207. As can be seen in FIG. 2, the first satellite 201 is illuminated by sunlight 207. The second satellite 203, however, is in the shade 209 of the Earth 205, and is therefore not illuminated by sunlight 207. Therefore, photovoltaic cells 213 on satellite 203 will not be able to generate electricity, unlike the photovoltaic cells 211 on satellite 201 which are in the sunlight 207.

However, to overcome this, satellite 201 can wirelessly transmit power to satellite 203. This is illustrated by dotted arrow 211 in FIG. 2.

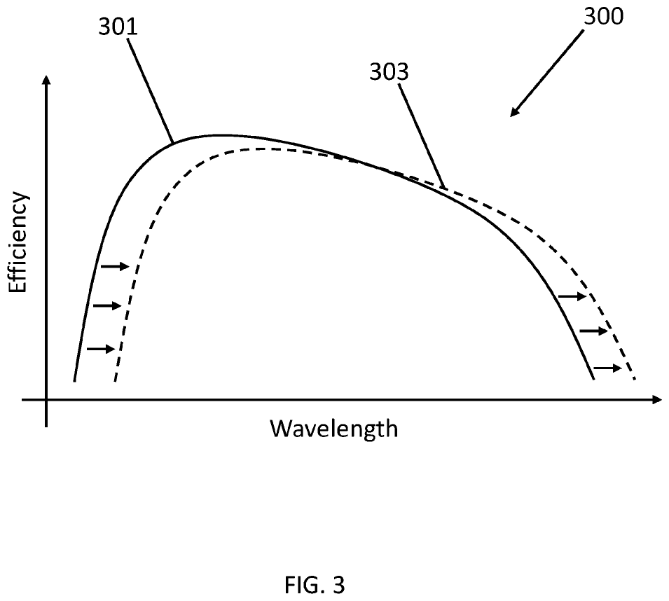

Different photovoltaic technologies will generate electricity in accordance to the electronic band-gap of the photovoltaic material as well as surface coatings, which in turn control the wavelengths of light it will interact with. This can be illustrated as an EQE (External Quantum Efficiency) spectral response curve 300, such as that illustrated in FIG. 3. The EQE of a photovoltaic cell is the ratio of the number of charge carriers collected by the photovoltaic cell to the number of incident photons of a given wavelength. The external efficiency of a photovoltaic cell varies with the wavelength of light received, based on the band-gaps and thicknesses of the photovoltaic cell, as can be seen by the illustrative EQE curve 301 of FIG. 3. Therefore, a photovoltaic cell will be able to convert incident light energy of different wavelengths into electrical energy with differing efficiencies. Different photovoltaic cells will have a different theoretical optimally efficient wavelength of incident light for producing electricity.

However, the practical efficiency of a photovoltaic cell can vary with the age and temperature of the photovoltaic, among other potential factors such as environmental factors, coatings on the photovoltaic cell, and the angle of incidence of illuminating light. The effect of these factors can be represented on an EQE spectral response curve by a shift and/or change in the EQE curve, illustrated by EQE curve 303, representing a change from the theoretical EQE curve 301. As can be seen in EQE spectral response curve 300, changed EQE curve 303 has a different wavelength response compared to EQE curve 301. In particular, the wavelength having the highest efficiency for EQE curve 303 is different from the wavelength having the highest efficiency for EQE curve 301.

Whilst it may be possible to predict how the actual EQE curve for a photovoltaic cell differs from the theoretical EQE curve, this will often be very difficult as the exact conditions and history of a photovoltaic cell may not be known. This is especially so for photovoltaic cells in space or on space objects, such as on satellites 201, 203. Furthermore, not all of the factors that may vary the EQE of a photovoltaic cell may be known. Accordingly, in order to wirelessly transmit power, for example from satellite 201 to satellite 203, at an optimal efficiency, it is not sufficient merely to use the theoretical EQE curve of the photovoltaic cell that is the wireless power receiver. Indeed, in some cases, the structure of the wireless power receiver may not even be known and so it is impossible to determine a theoretical EQE curve at all. Other factors can also affect how able the wireless power receiver is able to convert the received wireless power into electrical energy, such as the temperature, environmental effects such as intervening particles or dust, particles or dust coating the wireless power receiver, coatings on the photovoltaic cell, and the angle of incidence of illuminating light and so forth.

The method 100 disclosed in FIG. 1 can enable the determination of a preferred wireless power transmission mode that inherently takes into account all of these factors.

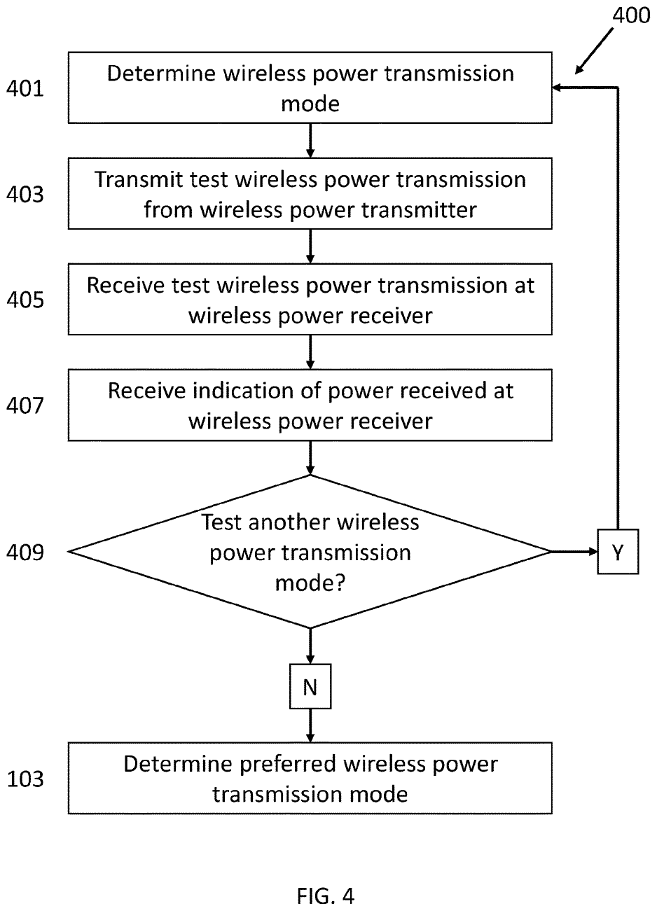

In some cases, the method used to determine the preferred wireless power transmission mode may be an iterative process. FIG. 4 illustrates a method 400. Method 400 is similar to method 100 shown in FIG. 1, but it breaks down step 101 of method 100 into a number of sub-steps 401 to 409.

Method 400 begins at step 401. Here, a wireless power transmission mode is determined. This is a wireless power transmission mode to be tested using a test wireless power transmission from the wireless power transmitter to the wireless power receiver.

As will be discussed in more detail shortly, method 400 comprises iterative components, and so the wireless power transmission mode determined at step 401 may be based on previous iterations of the iterative portion of method 400 (i.e., steps 401-409). However, for the first iteration of these steps 401-409, a wireless power transmission mode must still be determined at step 401 to initiate method 400, without the possibility of information derived from previous iterations.

In this case, the first wireless power transmission mode determined at step 401 may use other information, such as any knowledge of the wireless power receiver. For example, in the case of the wireless power receiver being a photovoltaic cell and the wireless power transmitter configured to transmit power wirelessly using lasers, the initial wireless power transmission mode may be based upon the structure of the photovoltaic cell, and in particular try to match its theoretical band gaps to the wavelengths of lasers available to the wireless power transmitter.

The initial wireless power transmission mode may also be a preset wireless power transmission mode, or selected from a list of preset wireless power transmission modes based upon some knowledge of the wireless power receiver. In this case, initial wireless power transmission mode may be configured to give the best starting point. For example, it may be a wireless power transmission mode that gives the most information about the receiver for use in determining subsequent wireless power transmission modes to test subsequently in the plurality of test wireless power transmissions.

A test wireless power transmission is then transmitted at step 403. This test wireless power transmission is a wireless power transmission according to the wireless power transmission mode determined at step 401, and is from the wireless power transmitter to the wireless power receiver.

This test wireless power transmission is received at the wireless power receiver at step 405, and at step 407 an indication of a power received at the wireless power receiver from the test wireless power transmission is received by the device doing the determining step 409 (which may be the wireless power receiver itself, the wireless power transmitter, or another device or cloud computing system, etc.).

At step 409, it is determined whether to test another wireless power transmission mode. That is, it is determined whether another test wireless power transmission should be sent from the wireless power transmitter to the wireless power receiver according to a different wireless power transmission mode to the mode (or modes) tested so far. If another wireless power transmission mode is to be tested, then the method goes back to step 401 of determining a wireless power transmission mode to be tested in the next test wireless power transmission. If no more wireless power transmission modes are to be tested, then the method proceeds to step 103 of determining a preferred wireless power transmission mode (according to the manner discussed with respect to method 100). Once the preferred wireless power transmission mode has been determined at step 103, the method may optionally comprise the additional step of transmitting power, from the wireless power transmitter to the wireless power receiver, according to the preferred wireless power transmission mode.

Whether or not to test another wireless power transmission mode at step 409 may be based on a number of different criteria. In some cases, the method may test a set number of wireless power transmission modes. For example, 6, 8 or 10 wireless power transmission modes may be tested (and all or some of the wireless power transmission modes to be tested may be predetermined). If, at step 409, the set number of wireless power transmission modes have already been tested, then the method will proceed to step 103; otherwise, the method will return to step 401.

Alternatively, a minimum number of wireless power transmission modes may be tested. This minimum number may correspond to an initial set of wireless power transmission modes to be tested, and once the initial set of wireless power transmission modes has been tested then the method may or may not, at step 409, determine to test further wireless power transmission modes or not (e.g., in accordance with the criteria below). The initial set of wireless power transmission modes may be a predetermined set of wireless power transmission modes that have been found to provide an efficient way of gathering useful data about the wireless power receiver, and in particular may be based on details (e.g., the structure) of the wireless power receiver if known. That is, different initial sets of wireless power transmission modes may be used for different wireless power receivers. Alternatively, a random selection of wireless power transmission modes may be used in the initial set of wireless power transmission modes which may be an effective way of gathering useful data about the wireless power receiver, particularly when little or no information about the wireless power receiver is known.

In some implementations, other criteria may be considered. In particular, the result of one or more of the previous test wireless power transmissions may be considered. For example, the method may continue testing wireless power transmission modes until an optimal mode has been determined. An optimal mode may be a mode that is considered “good enough” according to one or more operational parameters (e.g., a certain threshold efficiency, such as 75% of a theoretical maximum efficiency for converting energy transmitted from the wireless power transmitter into electrical energy by the wireless power receiver).

It may be considered that an optimal mode has been determined when the difference in received power (determined at step 407) for two or more consecutive test wireless power transmissions is negative (i.e., when less power was received from a test wireless power transmission than from the test wireless power transmission preceding it, or a defined number of test wireless power transmissions preceding it). Alternatively, if the difference is less than a threshold amount, e.g., if an increase in power received between a first test wireless power transmission and a second test wireless power transmission is less than a threshold amount, it may be determined that an optimal mode has been found.

Other factors may also be considered. For example, a certain amount of energy may be set aside for determining the preferred wireless power transmission mode, and so the method may move from step 409 to step 103 if this amount of energy has been expended during the test wireless power transmissions (or an amount of energy within a certain amount of the limit has been expended).

A combined approach may also be used. For example, the method may continue testing wireless power transmission modes until either an “optimal” power transmission mode has been determined or until a set number of iterations have been performed.

Due to the iterative nature of steps 401-409, it is important that the results of each test wireless power transmission can be correctly associated with the wireless power transmission mode being tested. In order to enable this, a “cue flash” may be implemented. This can be implemented as a pattern of lasers flashes that indicate the beginning of the test wireless power transmission. This will also ensure that the results of background or random illumination is not mistaken for a test wireless power transmission. As well as cue flashes being used to initiate the test, the can be included throughout the test at predefined locations (e.g., every four test wireless power transmissions) to ensure that the indications of received power continue to be matched with he correct test wireless power transmissions.

In some cases, this cue flash may also indicate which test wireless power transmission it belongs to. For example, the first test wireless power transmission may have a first cue flash laser pattern, the second test wireless power transmission may have a second cue flash laser patter, and so on. This can be particularly beneficial when the wireless power transmission modes are being tested according to a set pattern, rather than being iteratively updated for each subsequent test wireless power transmission based on the results of previous test wireless power transmissions. This is because it enables all of the test wireless power transmissions to be performed in rapid succession whilst still enabling the power received from each test wireless power transmission to be individually identified.

At each iteration, the step 401 of determining a wireless power transmission mode to test in the subsequent test wireless power transmission may be, in part, based on the results of previous test wireless power transmissions. This may allow a more efficient determination of the preferred wireless power transmission mode for a given set of criteria. A genetic algorithm can be used in this regard, which can vary the parameters of the wireless power transmission mode for subsequent test wireless power transmissions to optimise the wireless power transmission mode based on previous test wireless power transmissions.

In some preferred implementations of method 400, the results of at least two previous test wireless power transmissions may be used when determining a wireless power transmission mode at step 401. For example, in one scenario the criteria desired to be optimised is the amount of energy transferred (i.e., the preferred wireless power transmission mode is that which enables the wireless power receiver to receive the greatest amount of energy from a wireless power transmission). If increasing a given parameter of the wireless power transmission mode tested increases the power received at the wireless power receiver, this parameter may be increased further for a third test wireless power transmission to see if this again increases the power received further. If it does, the parameter may be increased further in for a fourth test wireless power transmission (and so on), until the power received at the wireless power receiver no longer increases when the parameter increases. In this case, further tests may be performed varying the parameter around the value found to have given the highest power received in the tests.

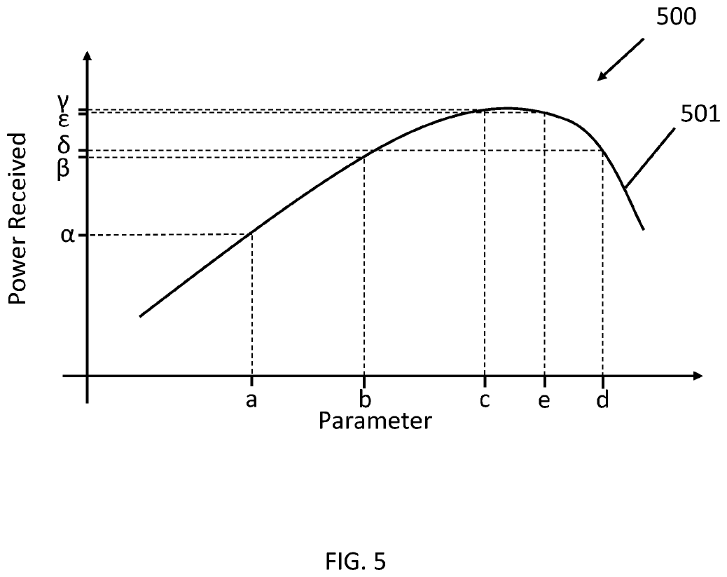

This iterative process is illustrated by graph 500 in FIG. 5. Graph 500 plots a curve 501 showing how a power received varies with an arbitrary parameter. FIG. 5 shows how the power received varies with a single parameter, and hence illustrates this as curve 501. However, in practice, multiple parameters can be investigated, in which case curve 501 may be a multidimensional surface.

In practice, the relationship between the parameter(s) and the power received is not known, and the purpose of the iterative process is essentially to determine the maximum of this curve (or surface for multiple parameters). A first test wireless power transmission may be conducted with the parameter having value a, giving a power received of α. A second test wireless power transmission is conducted with the parameter having a value b, where b>a, giving a receiver power β, where β>α. As increasing the parameter increased the received power, a third test may also be conducted increasing the parameter to c, where c>b, giving received power γ, where γ>β. Because, once again, this increase in the parameter has lead to an increase in the power received, the parameter may be increased again in a fourth test wireless power transmission. The fourth test wireless power transmission tests the parameter with value d, where d>c. However, with the parameter having value d, the received power is δ, where δ<γ. Therefore, it can be expected that increasing the parameter further will lead to lower power received. Instead, a further test could try a parameter value e, where c<e<d. This gives a power received of ε, where δ<ε<γ. Therefore, whilst the value e is better than the value d, it is still worse than c. A next test could test the parameter having a value between c and e, or between b and c (as it is not necessarily known which side of the peak c is). It should be appreciated, however, that when using an iterative approach the uncertainty in system should be taken into account. For example, if the difference between the received power ε and γ was less than the uncertainty in the received power, it cannot be necessarily decided that e is a less optimal value for the parameter than c. Rather, both parameters may be considered optimal or further tests should be performed.

This is merely an example of a simply iterative optimisation process, illustrating how subsequent tests can use information from preceding tests to converge on an optimal solution. Many more advanced techniques are known in the art and can be applied to this method, and the method is not limited. In particular, as noted previously, genetic algorithms have been found to be beneficial in informing how to vary the parameters of a wireless power transmission mode between tests for optimising one or more parameters of the wireless power transmission mode.

Other techniques may also be used, alone or in combination, for enabling an optimal mode to be determined. In some cases, the method may start by varying the parameters of the wireless power transmission mode in subsequent test wireless power transmissions in a set manner. This may enable a suitable starting point for a genetic algorithm or other iterative approach. For example, this may help to find a global maximum rather than just a local maximum of a desired output criterion.

As discussed above, FIG. 5 illustrates how the power received may vary with an arbitrary parameter. A number of different parameters may be tested, such as laser wavelength, laser intensity, pulse mode, etc., to enable a determination of a suitable preferred wireless power transmission mode. In this case, the curve 501 may in fact be a surface having a dimensionality equal to the number of parameters being tested. These parameters may be tested at the same time (i.e., between different iterations of steps 401 to 409 of FIG. 4, multiple parameters may be varied), or independently to some extent (i.e., steps 401 to 409 may be repeated determining an optimum value for each parameter one at a time, before moving onto the next parameter). This may, however, be less desirable as the parameters may not be independent, and so varying one may alter the optimum value of another.

As well as using an iterative method as described above, the method can utilise a knowledge of the wireless power receiver. For example, as discussed above, photovoltaic cells have an EQE which can describe how much power will be received from a laser at different wavelengths (e.g., as described with respect to FIG. 3). Testing different wavelengths within a single test wireless power transmission or across different test wireless power transmissions can allow an estimation of the EQE spectral response curve for a photovoltaic cell to be produced. Different wavelengths can be tested in a single test wireless power transmission where multiple lasers are used in the test wireless power transmission.

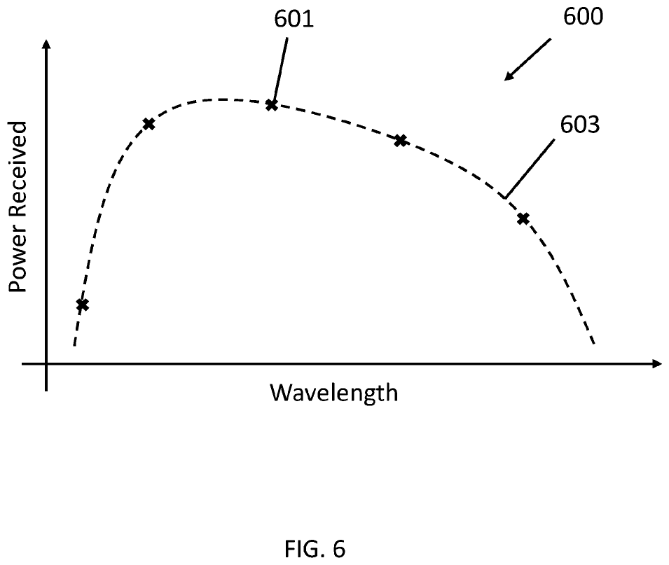

FIG. 6 illustrates on graph 600 a simple, exemplary means for how the EQE spectral response curve 603 for a single junction photovoltaic cell can be recreated from a plurality of test wireless power transmissions. In this case, five test wireless power transmissions were performed at five different wavelengths. The power received at the wireless power receiver for each test wireless power transmission can be recorded, and the results plotted as points 601 on graph 600. An EQE curve 603 can then be fitted. This fitting may take into account expected properties (e.g., shapes) of EQE curves.

It will be appreciated that this is only an illustration of the principle, and that in practice more complex modelling techniques may be used to model the EQE spectral response curve based on the test wireless power transmission results. In particular, this illustrative example modelled an EQE curve for a single junction photovoltaic cell. For multi-junction photovoltaic cells the spectral response curve will be more complex.

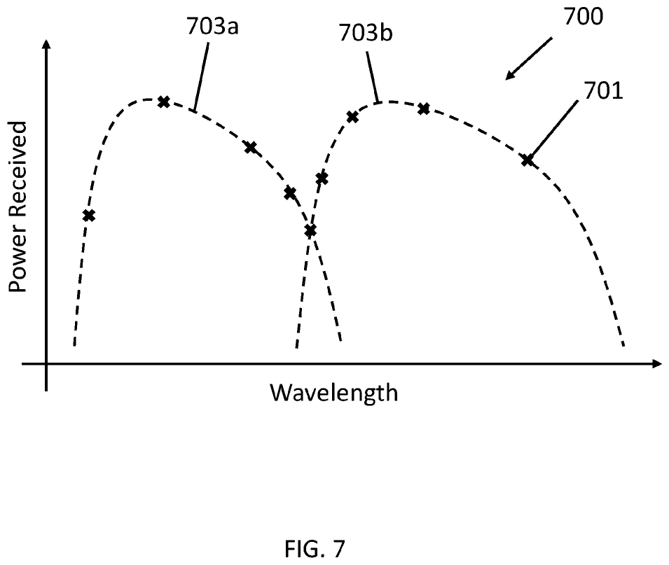

For example, FIG. 7 shows graph 700 which illustrates an EQE spectral response curve for a representative photovoltaic cell having two junctions. Here, it can be seen how the two individual spectral response curves 703a, 703b for each junction interact to provide the overall EQE spectral response of the photovoltaic cell. This EQE spectral response can be estimated in much the same way as discussed above in relation to FIG. 6, by plotting points 701 based on the results of the test wireless power transmission results. However, it will be noted that where the two spectral response curves 703a, 703b meet, the resultant curve may have steep gradients corresponding to a high sensitivity in the EQE response of the photovoltaic cell to small changes in the wavelength of incident light. It may, therefore, be beneficial to test more wireless power transmission modes configured to probe the EQE curve at these wavelengths than at wavelengths where there is less sensitivity to changes in wavelength.

In general, for when determining a preferred wireless test power transmission, a small wavelength perturbation between two test modes can enable the gradient of the EQE spectral response curve to be determined (at least, whether it is positive or negative). This can aid in determining where peaks in the EQE spectral response curve are.

It is also noted that for multi-junction photovoltaic cells, the powers of different wavelength lasers will become more important, and provide another dimension that needs to be included in the model when determining the preferred wireless power transmission mode. That is, it may be desirable to test the same wavelength at different power levels (and/or pulse modes).

The benefits of modelling an EQE spectral response curve for a photovoltaic cell in this or another manner is that this EQE spectral response curve will be more reflective of a current state of the photovoltaic cell compared to a theoretical EQE spectral response curve, taking into account deterioration of the photovoltaic cell and any other effects that may have caused it to deviate from a theoretical EQE curve. Furthermore, modelling an EQE means that a better estimation of a preferred wireless power transmission mode can potentially be determined with using fewer test wireless power transmissions. It also means that, once the EQE curve has been modelled, an optimal power transmission mode can be calculated from it (which can avoid needing so many iterations of the method to hone in on the optimal power transmission mode).

Many photovoltaic cells, particularly in space or extra-terrestrial applications, utilise more than one type of semiconductor material in what are known as multi-junction cells, because they utilise multiple junctions, for example, made from different semiconductor materials. Each of these junctions will have different band gaps and thus will respond to light of different wavelengths. In order to ensure that such a multi-junction photovoltaic cell can efficiently receive power, it is important that all of these junctions are “activated”, that is, that it receives light with a wavelength corresponding to the band gap of each of the junctions. In sunlight, this is not an issue as the sun emits approximately as a black body over a broad spectrum. However, when illuminated by lasers only at specific wavelengths, this can be lead to a drastic drop in the efficiency of the photovoltaic cell. Furthermore, the optimal wavelengths required for each junction can vary based on factors such as temperature and age.

For wirelessly transmitting power to multi-junction photovoltaic cells, a wireless power transmitter preferably comprises a number of lasers of different wavelengths. These lasers can have wavelengths related to the band gaps of the junctions of commonly used multi-junction photovoltaic cells. A wireless power transmission mode can define some combination of these lasers being activated. The lasers to be activated may be based on a knowledge of the wireless power receiver (e.g., its structure, make, or model and so which lasers will likely best match the relevant band gaps). Alternatively, if nothing is known of the structure, a wireless power transmission mode may comprise a defined subset of the available lasers to test during a test wireless power transmissions. Subsequent test wireless power transmissions may test wireless power transmission modes that comprise a different combination of lasers, enabling the best lasers for transmitting power to the particular wireless power receiver to be determined.

At a minimum, it is desirable to have at least one laser for each junction of the wireless power receiver. For example, if the wireless power receiver is a two junction photovoltaic cell, the preferred wireless power transmission mode should define at least two lasers of different wavelengths to be used, one corresponding to the band gap of each junction. Otherwise, it will not be possible for both junctions to be suitably activated by the laser light and only very poor power transfer efficiencies will be obtained. If the structure of the photovoltaic cell is known, then during the testing phase (e.g., step 301 of method 300), each wireless power transmission mode that is tested can specify a plurality of lasers, each having a wavelength targeting one of the band gaps. The properties of these lasers (e.g., power, pulse mode, etc.) or even the lasers used (i.e., using different length wavelength lasers) can be varied between subsequent test wireless power transmissions to enable a determination of the preferred wireless power transmission mode.

More preferably, however, more than one lasers (of different wavelengths) per junction can be defined in the wireless power transmission modes being tested. Whilst this may use more power and require a more complicated and larger wireless power transmitter (e.g., with more available lasers to use), using more than one lasers per junction provides more information about the current state of the photovoltaic cell, and how the EQE of the photovoltaic cell may have varied from the theoretical values over its lifetime. This can mean that fewer wireless power transmission modes may need to be tested to determine a suitable preferred wireless power transmission mode. It also means that a better model of the EQE curve of the wireless power receiver can be formed, which can enable both a quicker determination of the preferred wireless power transmission mode (i.e., fewer test transmissions) and a better preferred wireless power transmission mode to be determined (i.e., more optimised for the desired characteristics, such as total energy transmitted or efficiency of energy transmitted). It is noted that the wavelengths for each junction need not be unique. For example, for a wireless power receiver that is a photovoltaic cell having four junctions, six different wavelengths may be used. In this way, each junction can have two wavelengths targeting it, with some wavelengths targeting multiple junctions. This can be thought of as 1.5 wavelengths per junction. In a preferable example, two or more lasers per junction are used.

As well as considering how the wavelengths of the lasers defined in the wireless power transmission mode will interact with the photovoltaic wireless power receiver, it has been found that it is also important to consider the powers of the lasers. As well as matching up wavelengths of the lasers used to the band gaps of the junctions, it has also been found that in order to provide the optimal overall efficiency in converting the received laser light into electrical energy, the powers of the lasers corresponding to each junction must also be appropriately balanced. Individual junctions must not be “overloaded”, that is, the corresponding laser must not be too powerful in comparison to the lasers corresponding to the other junctions, or an overall decrease in efficiency will be observed. Therefore, as well as testing different wavelengths in the plurality of test wireless power transmissions, it is also, therefore, beneficial to very the powers of the lasers being used to determine an optimum balance of powers across the different wavelengths. In a similar way, and for similar reasons, the pulse mode can also be varied across the plurality of test wireless power transmissions.

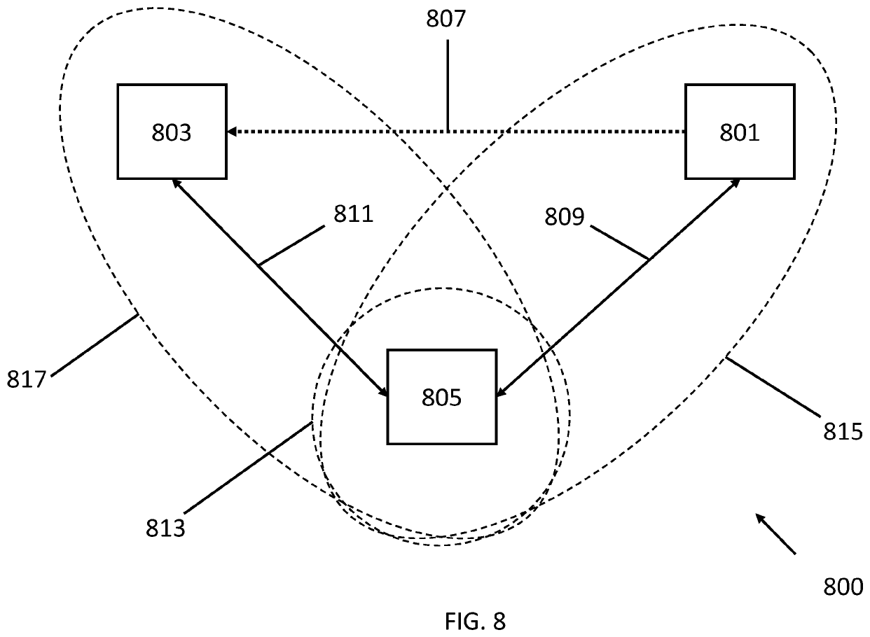

The methods described herein can be implemented in a number of different arrangements in a number of different contexts. FIG. 8 illustrates a schematic representation of a system 800 configured to carry out the methods described herein.

System 800 comprises a wireless power transmitter 801, a wireless power receiver 803, and a processing system 805. The wireless power transmitter 801 and the wireless power receiver 803, may, for example, be satellite 201 and 203 of FIG. 2 respectively. The wireless power transmitter 801 is capable of transmitting power wirelessly (dotted line 807) to the wireless power receiver 803. The wireless power receiver 803 is in communication (line 811) with the processing system 805, which can receive an indication of a power received at the wireless power receiver 803 for a wireless power transmission 807 from the wireless power receiver 803.

The processing system 805 is also in communication (line 809) with the wireless power transmitter 801. The processing system 805 can determine a wireless power transmission mode to be tested and send this to the wireless power transmitter 801. This may be, in part, based on the indication of power received at the wireless power receiver 803 received by the processing system 805 for previous test wireless power transmissions. The processing system 805 can also determine a preferred wireless power transmission mode, based on the indications of power received by the wireless power receiver 803 for a plurality of test wireless power transmissions. The preferred wireless power transmission mode can then be sent from the processing system 805 to the wireless power transmitter 801. The processing system 805 may also determine whether to continue testing further wireless power transmission modes or not.

In some implementations, the processing system 805 may be separate from the wireless power transmitter 801 and the wireless power receiver 803 (represented by dashed circle 813). In this case, it may be implemented on a separate computer or computer network, or implemented in the cloud or other suitable computing environment. Alternatively, the processing system 805 may be a part of a wireless power transmitting device 815 that comprises both the wireless power transmitter 801 and the processing system 805. In this case, the wireless power transmitting device 815 is in communication with the wireless power receiver 803. As yet another alternative, the processing system 805 may be a part of a wireless power receiving device 817 that comprises both the wireless power receiver 803 and the processing system 805. In this case, the wireless power receiving device 817 is in communication with the wireless power transmitter 801.

It will be appreciated that the steps of the methods described herein may be performed by different parts of system 800 depending upon how system 800 is configured. In particular, it will depend on whether processing system 805 is a separate processing system 813 from the wireless power transmitter 801 and the wireless power receiver 803, whether the processing system 805 is part of a wireless power transmitting device 815, or whether the processing system 805 is part of a wireless power receiving device 817.

With reference to method 400 of FIG. 4, it will be appreciated that step 403 of transmitting the test wireless power transmission from the wireless power transmitter 801 must be performed by the wireless power transmitter 801. Similarly, step 405 of receiving the test wireless power transmission at the wireless power receiver must be performed by the wireless power receiver 803. The processing steps, including step 401 of determining a wireless power transmission mode, step 407 of receiving an indication of power received at the wireless power receiver, step 409 of determining whether to test another wireless power transmission mode, and step 103 of determining a preferred wireless power transmission mode, are performed by processing system 805. Therefore, these steps may be performed by a wireless power transmitting device 815 incorporating the processing system 805, a wireless power receiving device 817 incorporating the processing system 805, or a processing system 813 separate from both the wireless power transmitter 801 and the wireless power receiver 803. The applicant, therefore, reserves the right to claim the method performed by the system as a whole, or any component part of it, in each of the configurations described.

As noted previously, the methods described herein are particularly beneficial in the space sector. The method can provide a means for determining a more optimal mode for transmitting power between two satellites compared to previous methods, enabling high power throughput and more efficient power transfer. Furthermore, the ability to determine the preferred wireless power mode does not necessarily rely on any action from the wireless power receiver other than it transmitting an indication of the power received from each test wireless power transmission. This is a capability that will be integral to existing satellites, e.g., for mission control and diagnostic purposes. The method can, therefore, be applied retroactively to enable optimised power transmission to satellites already in orbit. However, in one embodiment, satellites that will be the wireless power receiver are fitted with a specific module that comprises processing system 805, enabling them to perform the processing steps and inform the wireless power transmitter what wireless power transmission modes should be tested and what the finally determined preferred wireless power transmission mode is. This can reduce the computational burden on the wireless power transmitter satellite, and more easily enable it to service a greater number of wireless power receiving satellites.

In other implementations, the processing system 805 can be incorporated into a module of the wireless power transmitter satellite. This can be beneficial as it enables backward compatibility with wireless power receiving satellites that do not comprise a module capable of meeting the requirements of processing system 805, as noted above. Having the processing system 805 on the wireless power transmitting satellite has the benefit, compared to having the processing system 805 terrestrially located, of not relying on communications via terrestrial ground stations which may be delayed due to the longer time of flight, may undergo more interference due to weather and other factors, and may have more limited bandwidth due to regulatory requirements. On the other hand, locating processing system 805 on Earth (or indeed another body that the wireless power receiving and transmitting satellites may be orbiting) means that it will be easier to increase the computing power available as well as enabling a single processing system 805 to service multiple wireless power transmitting satellites (whilst maintaining the same backward compatibility benefits of locating processing system 805 on the wireless power transmitting satellite). As another alternative, the processing system 805 may be located in orbit, but separate from the wireless power transmitter 801 and the wireless power receiver 803. For example, it may be distributed over one or more other satellites (i.e., in orbit computing). In some cases, the processing system 805 may be distributed across orbital and terrestrial computer systems. Generally, the processing system 805 will comprise of one or more memory components (e.g., hard drives, solid state memory, RAM, EPROM, etc.) having stored thereon instructions that will cause the processing system to implement the processing steps of the methods disclosed herein and one or more processor components configured to perform the processing steps. Preferably, the processing system 805 will also comprise, or be in communication with, transmittors and/or receivers to communicate with other parts of system 800 as necessary.

It will be appreciated that the above disclosure is exemplary in nature and intended only to illustrate the invention claimed. Various modifications to the aspects described above will be apparent to the skilled person. For example, it will be appreciated that in general tests of parameters may be repeated as necessary to increase the confidence in a result, because a transmission was interrupted, and so forth. It will also be appreciated that a test wireless power transmission may not comprise one continuous transmission, but may rather comprise a series of separate transmissions that may be spread out over a time period substantially greater than the time over which power is actually being transmitted. Furthermore, different test transmissions may have different durations, depending upon the parameters being tested, the amount of data needed to have a given confidence level in the result, and so on.

The methods described above may, in some implementations, only need to be performed once between any two wireless power transmitters and receivers. However, in practice, the preferred wireless power transmission mode may need to be re-determined at intervals. In the case of satellites, this may be during each pass between the wireless power transmitter and wireless power receiver (or even multiple times within a single pass) to account for changing factors such as the orientation of the wireless power transmitter and receiver, which may effect the preferred wireless power transmission mode. However, regardless of wether the wireless power transmitter and wireless power receiver are moving relative to one another, it may be preferable to re-determine the preferred wireless power transmission mode at one or more intervals. This can take into account how the preferred wireless power transmission mode may vary with different amounts of energy desired to be transmitted wirelessly, to take into account environmental factors such as weather, or simply to take into account the natural degradation of the wireless power transmitter and/or wireless power receiver over their lifetimes.

Particular aspects of the invention are set out in the following numbered clauses:

1. A method of determining a preferred wireless power transmission mode comprising:
receiving an indication of a power received at a wireless power receiver for each of a plurality of test wireless power transmissions received at the wireless power receiver, at least two of the wireless power transmissions corresponding to a different wireless power transmission mode; and
determining a preferred wireless power transmission mode based on the indications of power received by the wireless power receiver for at least one of the test wireless power transmissions.

2. The method of clause 1, wherein each wireless power transmission mode defines a combination of at least two laser pulses, each of the at least two laser pulses having at least a different wavelength, a different instantaneous or average power, or a different pulse mode from each of the other at least two laser pulses.

3. The method of clause 1 or 2, wherein each of the plurality of test wireless power transmissions are received by the wireless power receiver sequentially; and
wherein between each test wireless power transmission the method further comprises determining the wireless power transmission mode to be used for the next test wireless power transmission.

4. The method of clause 3, wherein the determination of the wireless power transmission mode to be used for the next test wireless power transmission is based on at least one of the previously received indications of a power received at the wireless power receiver and the wireless power transmission mode used in a previous test wireless power transmission.

5. The method of clause 3 or 4, wherein a genetic algorithm and/or machine learning is used to determine the wireless power transmission mode to be used for the next test wireless power transmission.

6. The method of any of clauses 3 to 5, wherein no further wireless power transmission modes are determined if the power received from the most recent test wireless power transmission is either less than or within a certain threshold of the power received from the test wireless power transmission preceding the most recent test wireless power transmission.

7. The method of any preceding clause, wherein the number of test wireless power transmissions in the plurality of test wireless power transmissions does not exceed a predetermined number.

8. The method of any preceding clause, wherein the plurality of test wireless power transmissions comprises an initial one or more test wireless power transmissions; and
wherein each of the initial one or more test wireless power transmissions corresponds to a predetermined wireless power transmission mode.

9. The method of any preceding clause, wherein the method is configured to be used with a wireless power receiver comprising a photovoltaic cell; and
wherein each wireless power transmission mode comprises at least a number of different wavelengths equal to the number of junctions of the photovoltaic cell.

10. The method of clause 9 wherein the wavelengths are based on the band gaps of the junctions of the photovoltaic cell.

11. The method of any preceding clause, wherein determining a preferred wireless power transmission mode based on the indications of power received by the wireless power receiver for each of the test wireless power transmissions comprises selecting a wireless power transmission mode corresponding to one of the test wireless power transmissions as the preferred wireless power transmission mode.

12. The method of any of clauses 2 to 11, wherein determining a preferred wireless power transmission mode based on the indications of power received by the wireless power receiver for each of the test wireless power transmissions comprises:
estimating an external quantum efficiency spectral response curve based on the indications of power received by the wireless power receiver for each of the test wireless power transmissions; and
determining the preferred wireless power transmission mode based on the external quantum efficiency spectral response curve.

13. The method of clause 12, wherein the preferred wireless power transmission mode is further determined based on the lasers available to a wireless power transmitter.

14. The method of any preceding clause, wherein the preferred wireless power transmission mode is determined using artificial intelligence, such as a neural network.

15. The method of clause 14, wherein the artificial intelligence is trained on training data derived from previous implementations of the method.

16. The method of any preceding clause, wherein the preferred wireless power transmission mode is a wireless power transmission mode that enables the wireless power receiver to receive a maximum power or a specified amount of power.

17. The method of any of clauses 1 to 15, wherein the preferred wireless power transmission mode is a wireless power transmission mode that enables the most efficient wireless transfer of power from a wireless power transmitter to the wireless power receiver.

18. The method of any of clauses 1 to 17, wherein the preferred wireless power transmission mode is a wireless power transmission mode that enables wireless power transfer to the wireless power receiver without causing the temperature of the wireless power receiver and/or the wireless power transmitter to increase more than a threshold amount.

19. The method of any of clauses 1 to 18, wherein the preferred wireless power transmission mode is a wireless power transmission mode that causes least degradation of the wireless power receiver and/or the wireless power transmitter.

20. The method of any preceding clause, further comprising, for each of the plurality of test wireless power transmissions, transmitting the test wireless power transmission to the wireless power receiver.

21. The method of any preceding clause, further comprising wirelessly transmitting power, from the wireless power transmitter to the wireless power receiver, according to the preferred wireless power transmission mode.

22. The method of any preceding clause, wherein one or both of the wireless power transmitter and the wireless power receiver are space objects, optionally satellites.

23. A computer program configured to cause a computing system to perform the method of any preceding clause when executed.

24. A non-transitory memory having stored thereon the computer program of clause 23.

25. A satellite configured to perform the method of any of clauses 1 to 22.

1. A method of determining a preferred wireless laser power transmission mode comprising:
receiving an indication of a power received at a wireless power receiver for each of a plurality of test wireless laser power transmissions received at the wireless power receiver, at least two of the test wireless laser power transmissions corresponding to different wireless laser power transmission modes; and
determining a preferred wireless laser power transmission mode based on the indications of power received by the wireless power receiver for at least one of the test wireless power transmissions;
wherein each wireless laser power transmission mode defines a combination of at least two laser pulses, each of the at least two laser pulses having a different wavelength.

2. The method of claim 1, wherein each of the plurality of test wireless laser power transmissions are received by the wireless power receiver sequentially; and
wherein between each test wireless laser power transmission the method further comprises determining the wireless laser power transmission mode to be used for the next test wireless laser power transmission.

3. The method of claim 2, wherein the determination of the wireless laser power transmission mode to be used for the next test wireless laser power transmission is based on at least one of the previously received indications of a power received at the wireless power receiver and the wireless laser power transmission mode used in a previous test wireless laser power transmission.

4. The method of claim 3, wherein a genetic algorithm and/or machine learning is used to determine the wireless laser power transmission mode to be used for the next test wireless laser power transmission.

5. The method of claim 2, wherein no further wireless laser power transmission modes are determined if the power received from the most recent test wireless laser power transmission is either less than or within a certain threshold of the power received from the test wireless laser power transmission preceding the most recent test wireless laser power transmission.

6. The method of claim 5, wherein the number of test wireless laser power transmissions in the plurality of test wireless laser power transmissions does not exceed a predetermined number.

7. The method of claim 6, wherein the plurality of test wireless laser power transmissions comprises an initial one or more test wireless laser power transmissions; and
wherein each of the initial one or more test wireless laser power transmissions corresponds to a predetermined wireless laser power transmission mode.

8. The method of claim 1, wherein the method is configured to be used with a wireless power receiver comprising a photovoltaic cell; and
wherein each wireless laser power transmission mode comprises at least a number of different wavelengths equal to the number of junctions of the photovoltaic cell.

9. The method of claim 8 wherein the wavelengths are based on the band gaps of the junctions of the photovoltaic cell.

10. The method of claim 1, wherein determining a preferred wireless laser power transmission mode based on the indications of power received by the wireless power receiver for each of the test wireless laser power transmissions comprises selecting a wireless laser power transmission mode corresponding to one of the test wireless laser power transmissions as the preferred wireless laser power transmission mode.

11. The method of claim 10, wherein determining a preferred wireless laser power transmission mode based on the indications of power received by the wireless power receiver for each of the test wireless laser power transmissions comprises:
estimating an external quantum efficiency spectral response curve based on the indications of power received by the wireless power receiver for each of the test wireless laser power transmissions; and
determining the preferred wireless laser power transmission mode based on the external quantum efficiency spectral response curve.

12. The method of claim 2, wherein the preferred wireless laser power transmission mode is determined using artificial intelligence, such as a neural network.

13. The method of claim 12, wherein the artificial intelligence is trained on training data derived from previous implementations of the method.

14-18. (canceled)

19. The method of claim 1, further comprising, for each of the plurality of test wireless laser power transmissions, transmitting the test wireless laser power transmission to the wireless power receiver.

20. The method of claim 1, further comprising wirelessly transmitting power, from the wireless power transmitter to the wireless power receiver, according to the preferred wireless laser power transmission mode.

21. The method of claim 20, wherein one or both of the wireless power transmitter and the wireless power receiver are space objects.

22. The method of claim 21, wherein the space objects are satellites.

23. A computer program configured to cause a computing system to perform the method of claim 1 when executed.

24. A non-transitory memory having stored thereon the computer program of claim 23.

25. A satellite configured to perform the method of claim 1.
